(19) United States
(12) Patent Application Publication
(10) Pub. No.: US 2026/0247092 A1
(43) Pub. Date: Aug. 20, 2026

(54) DISTRIBUTED HEAD TRACKING

(71) Applicant: DOLBY LABORATORIES LICENSING CORPORATION

(72) Inventors: Yuxing Hao, Beijing (CN); Zilong Yang, Beijing (CN); Xuemei Yu, Beijing (CN)

(73) Assignee: DOLBY LABORATORIES LICENSING CORPORATION, (US)

(21) Appl. No.: 19/164,782

(22) PCT Filed: Mar. 13, 2024
(86) PCT No.: PCT/US2024/019804

§ 371 Date: Sep. 12, 2025

Related U.S. Application Data
(60) Provisional application No. 63/517,561, filed on Aug. 3, 2023.

(30) Foreign Application Priority Data
Mar. 16, 2023 (WO) PCT/CN2023/081947

(51) Int. Cl. H04S 7/00; G01P 13/00; H04R 5/033

(52) U.S. Cl. CPC H04S 7/301; G01P 13/00; H04R 5/033; H04S 2400/11

(57) ABSTRACT

Techniques for determining headtracking information are provided. In some embodiments, a method involves receiving, at a mobile device, motion information from a set of earbuds paired with the mobile device. The method may involve determining rotation information associated with rotation to be applied to a sound field in accordance with a headtracking mode of operation. In a first mode, the motion information received from the earbuds corresponds to the determined rotation information. In a second mode, the motion information received from the earbuds comprises initial rotation information, and the initial rotation information is combined with motion information obtained via sensors of the mobile device to determine the rotation information. In a third mode, the motion information received from the earbuds comprises motion sensor data, and the motion sensor data is combined with motion information obtained via sensors of the mobile device to determine the rotation information.

### CROSS-REFERENCE TO RELATED APPLICATIONS

This application claims the benefit of priority of U.S. Provisional Patent Application No. 63/517,561, filed on Aug. 3, 2023, and PCT Application No. PCT/CN2023/081947, filed on Mar. 16, 2023, all of which are incorporated herein by reference in their entirety.

### TECHNICAL FIELD

This disclosure pertains to systems, methods, and media for distributed head tracking.

### BACKGROUND

Listeners of audio content may want to listen to audio content, such as music, audio content associated with a movie or television show, or the like in an immersive manner, where audio content is rendered as if originating from particular spatial locations with respect to the listener's head orientation. However, it can be difficult to determine a spatial rotation of the sound field in accordance with the listener's head orientation.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

Techniques for determining headtracking information are provided. In some embodiments, a method for determining headtracking information may involve receiving, at a mobile device, motion information from a set of earbuds paired with the mobile device. The method may further involve determining rotation information associated with rotation to be applied to a sound field in accordance with a headtracking mode of operation, wherein: in a first mode of the headtracking mode of operation, the motion information received from the set of earbuds corresponds to the determined rotation information; in a second mode of the headtracking mode of operation, the motion information received from the set of earbuds comprises initial rotation information, and wherein the initial rotation information is combined with motion information obtained via one or more sensors of the mobile device to determine the rotation information; and in a third mode of the headtracking mode of operation, the motion information received from the set of earbuds comprises motion sensor data, and wherein the motion sensor data is combined with motion information obtained via the one or more sensors of the mobile device to determine the rotation information.

In some examples, the method further involves detecting a motion activity of a wearer of the set of earbuds, wherein the determined rotation information is based at least in part on the detected motion activity. In some examples, detecting the motion activity comprises determining whether the wearer is walking based at least in part on a comparison of a power of a frequency domain representation of the motion information to a threshold. In some examples, detecting the motion activity is performed by the set of earbuds. In some examples, detecting the motion activity is performed by the mobile device.

In some examples, the set of earbuds are configured to perform an auto-zeroing procedure to determine an updated reference axis corresponding to a user-facing direction, and wherein the determined rotation information is based at least in part on the reference axis. In some examples, determining the reference axis comprises: comparing a variance of a head orientation angle to a threshold; determining that the variance of the head orientation angle is below the threshold for a predetermined duration of time; and responsive to determining that the variance of the head orientation angle is below the threshold for the predetermined duration of time, determining the updated reference axis. In some examples, the threshold is set based at least in part on the variance.

In some examples, the set of earbuds are configured to perform a calibration procedure configured to compensate for a tilt of at least one earbud of the set of earbuds within an ear of a wearer of the set of earbuds. In some examples, the calibration procedure comprises determining a compensating rotation based on a quaternion representing an orientation of a head of the wearer.

In some examples, the mobile device is further configured to receive motion data from at least one other wearable device comprising at least one of: a smart watch, or a fitness tracker. In some examples, in the third mode of the headtracking mode of operation, the mobile device is configured to combine the motion data from the at least one other wearable device with the motion information obtained via the one or more sensors of the mobile device to determine the rotation information.

In some examples, the mobile device: determines that rotation information associated with rotation of the mobile device is to be used to determine the rotation to be applied to a sound field; and determines the rotation information used to determine the rotation to be applied to the sound field based on a yaw angle of the mobile device. In some examples, determining that the rotation information associated with the rotation of the mobile device is to be used to determine the rotation to be applied to the sound field comprises determining the rotation information associated with the rotation of the mobile device has a reliability that exceeds a reliability threshold, and that the mobile device has a stillness metric that is within a stillness threshold.

In some embodiments, a system comprises a set of earbuds, and a mobile device paired with the set of earbuds, wherein the mobile device comprises at least one processor configured to: receive, at a mobile device, motion information from a set of earbuds paired with the mobile device; and determine rotation information associated with rotation to be applied to a sound field in accordance with a headtracking mode of operation. In a first mode of the headtracking mode of operation, the motion information received from the set of earbuds corresponds to the determined rotation information. In a second mode of the headtracking mode of operation, the motion information received from the set of earbuds comprises initial rotation information, and wherein the initial rotation information is combined with motion information obtained via one or more sensors of the mobile device to determine the rotation information. In a third mode of the headtracking mode of operation, the motion information received from the set of earbuds comprises motion sensor data, and wherein the motion sensor data is combined with motion information obtained via the one or more sensors of the mobile device to determine the rotation information.

In some examples, at least one of the set of earbuds or the mobile device is configured to detect a motion activity of a wearer of the set of earbuds, wherein the determined rotation information is based at least in part on the detected motion activity. In some examples, detecting the motion activity comprises determining whether the wearer is walking based at least in part on a comparison of a power of a frequency domain representation of the motion information to a threshold.

In some examples, wherein the set of earbuds are configured to perform an auto-zeroing procedure to determine an updated reference axis corresponding to a user-facing direction, and wherein the determined rotation information is based at least in part on the reference axis. In some examples, determining the reference axis comprises: comparing a variance of a head orientation angle to a threshold; determining that the variance of the head orientation angle is below the threshold for a predetermined duration of time; and responsive to determining that the variance of the head orientation angle is below the threshold for the predetermined duration of time, determining the updated reference axis. In some examples, the threshold is set based at least in part on the variance.

In some examples, the set of earbuds are configured to perform a calibration procedure configured to compensate for a tilt of at least one earbud of the set of earbuds within an ear of a wearer of the set of earbuds. In some examples, the calibration procedure comprises determining a compensating rotation based on a quaternion representing an orientation of a head of the wearer.

In some examples, the mobile device is further configured to receive motion data from at least one other wearable device comprising at least one of: a smart watch, or a fitness tracker.

In some examples, the mobile device: determines that rotation information associated with rotation of the mobile device is to be used to determine the rotation to be applied to a sound field; and determines the rotation information used to determine the rotation to be applied to the sound field based on a yaw angle of the mobile device. In some examples, determining that the rotation information associated with the rotation of the mobile device is to be used to determine the rotation to be applied to the sound field comprises determining the rotation information associated with the rotation of the mobile device has a reliability that exceeds a reliability threshold, and that the mobile device has a stillness metric that is within a stillness threshold.

In some embodiments, a set of earbuds comprises: one or more motion sensors; and at least one processor. The at least one processor may be configured to: pair with a mobile device; and determine rotation information associated with rotation to be applied to a sound field in accordance with a headtracking mode of operation. In a first mode of the headtracking mode of operation, rotation information comprises motion data obtained from the one or more motion sensors of the set of earbuds. In a second mode of the headtracking mode of operation, the rotation information comprises a rotation vector determined by the at least one processor based on the motion data obtained from the one or more motion sensors of the set of earbuds. In a third mode of the headtracking mode of operation, the rotation information comprises yaw, pitch, and roll angles associated with a current head orientation of a wearer of the set of earbuds. The at least one processor may be further configured to provide the rotation information to the paired mobile device.

In some examples, the at least one processor is further configured to detect a motion activity of a wearer of the set of earbuds, wherein the determined rotation information is based at least in part on the detected motion activity. In some examples, detecting the motion activity comprises determining whether the wearer is walking based at least in part on a comparison of a power of a frequency domain representation of the motion information to a threshold.

In some examples, the at least one processor is configured to perform an auto-zeroing procedure to determine an updated reference axis corresponding to a user-facing direction, and wherein the determined rotation information is based at least in part on the reference axis. In some examples, determining the reference axis comprises: comparing a variance of a head orientation angle to a threshold; determining that the variance of the head orientation angle is below the threshold for a predetermined duration of time; and responsive to determining that the variance of the head orientation angle is below the threshold for the predetermined duration of time, determining the updated reference axis. In some examples, the threshold is set based at least in part on the variance.

In some examples, the at least one processor is further configured to perform a calibration procedure configured to compensate for a tilt of at least one earbud of the set of earbuds within an ear of a wearer of the set of earbuds. In some examples, the calibration procedure comprises determining a compensating rotation based on a quaternion representing an orientation of a head of the wearer.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRA WINGS

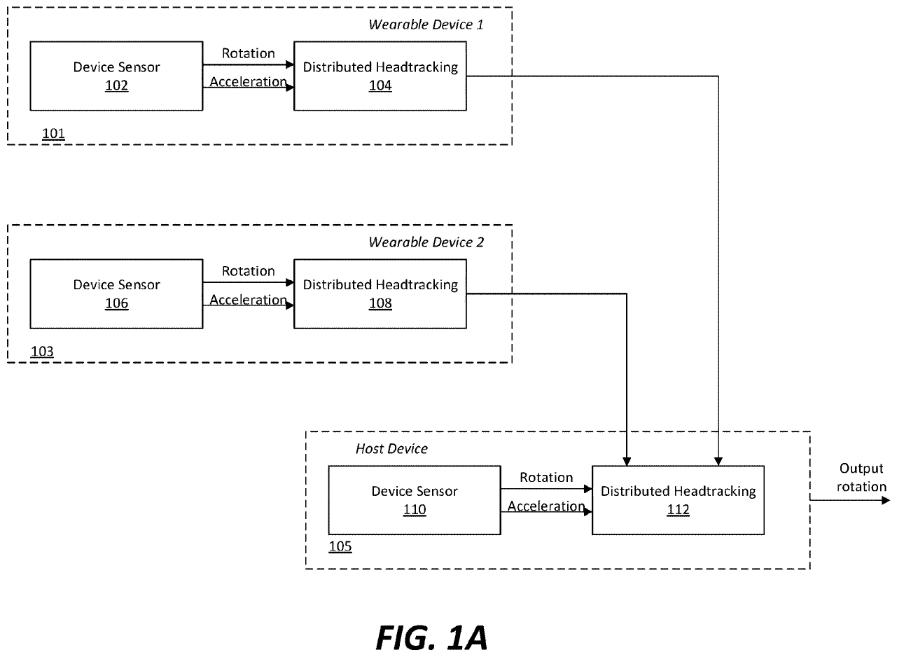

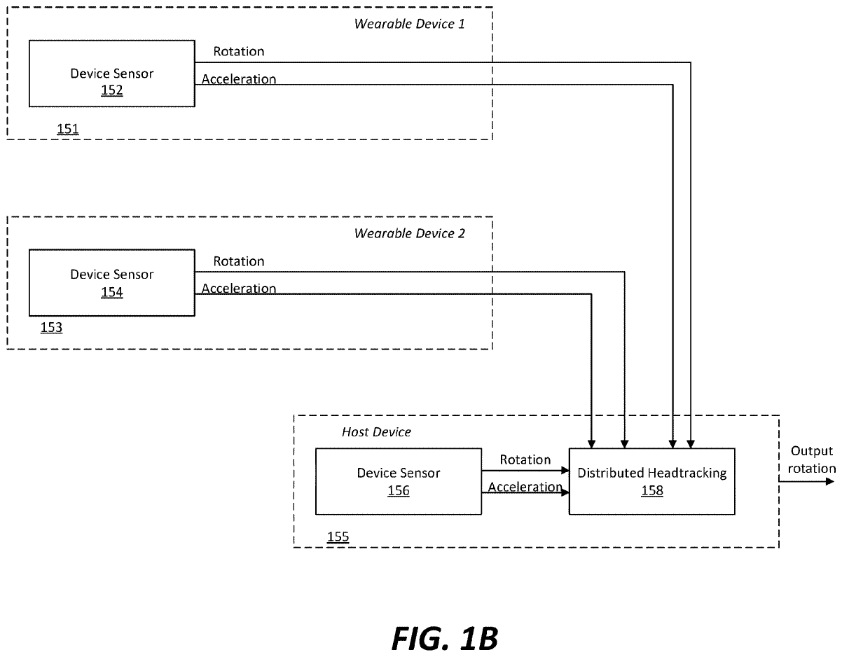

FIGS. 1A and 1B illustrate example configurations of a distributed headtracking system in accordance with some embodiments.

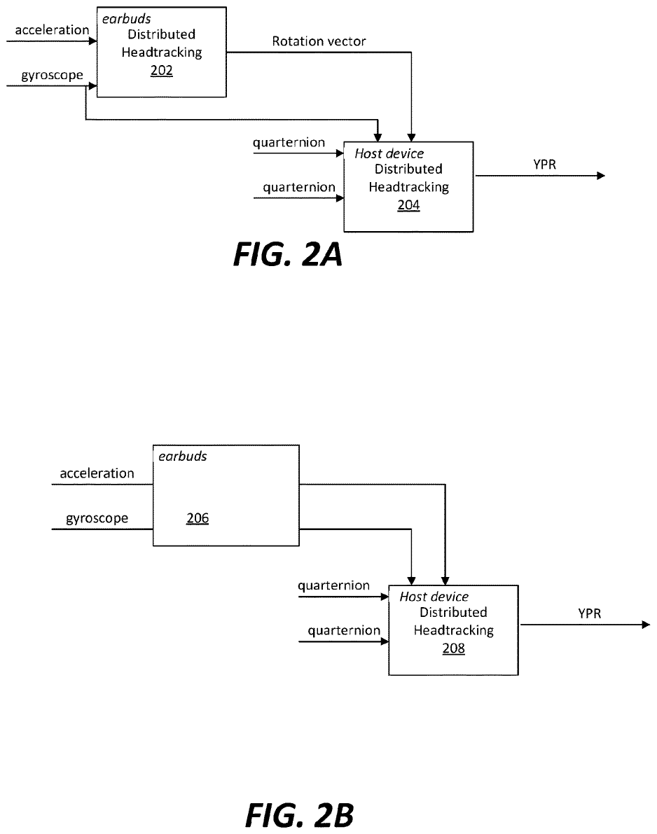

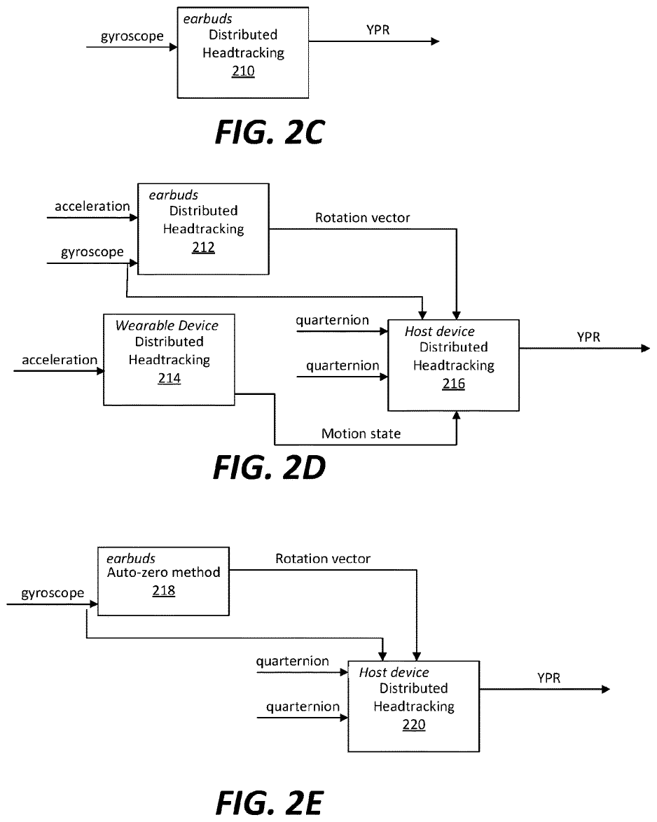

FIGS. 2A, 2B, 2C, 2D, and 2E illustrate example outputs of various configurations of distributed headtracking systems in accordance with some embodiments.

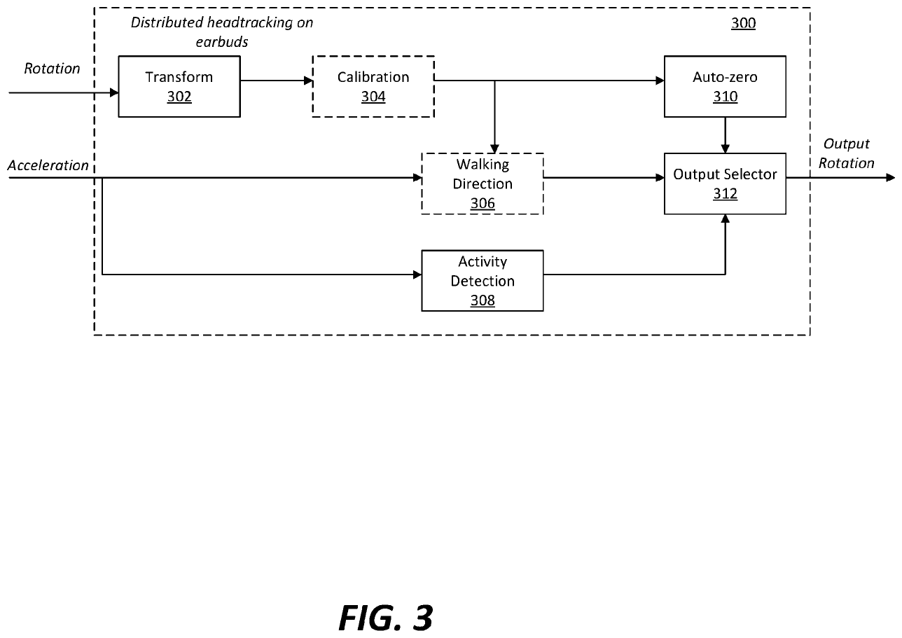

FIG. 3 illustrates an example distributed headtracking system instance implemented on a set of earbuds in accordance with some embodiments.

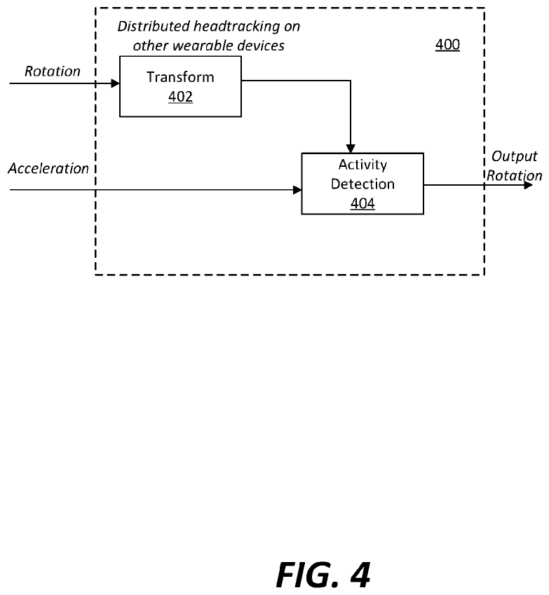

FIG. 4 illustrates an example distributed headtracking system instance implemented on a wearable device in accordance with some embodiments.

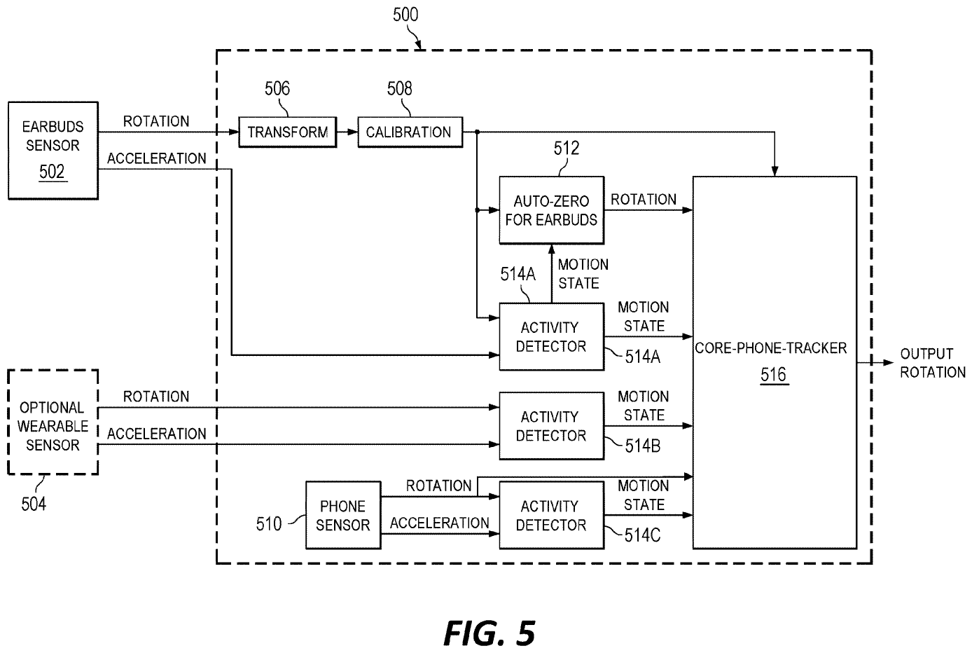

FIG. 5 illustrates an example distributed headtracking system instance implemented on a host device in accordance with some embodiments.

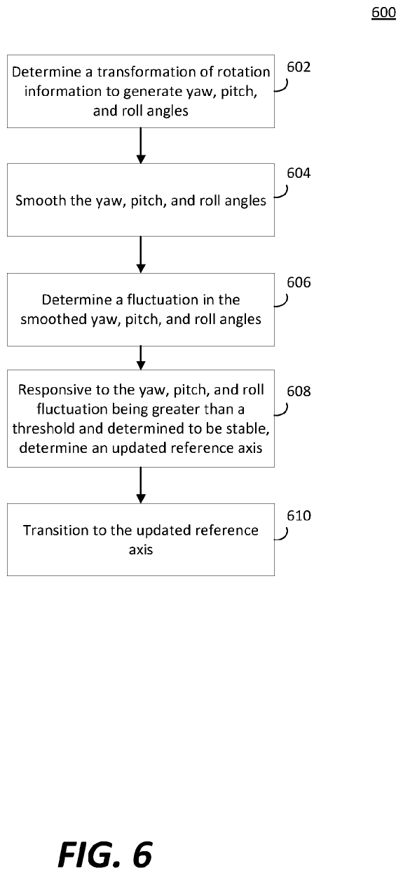

FIG. 6 is a flowchart of an example process for recentering a reference axis for a sound field orientation in accordance with some embodiments.

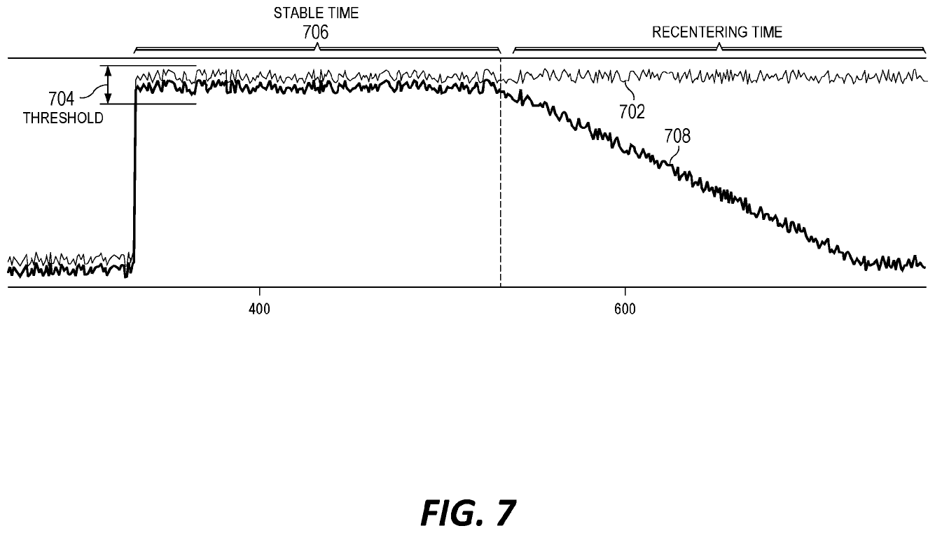

FIG. 7 is a graph of example sensor data that may be used to recenter a reference axis in accordance with some embodiments.

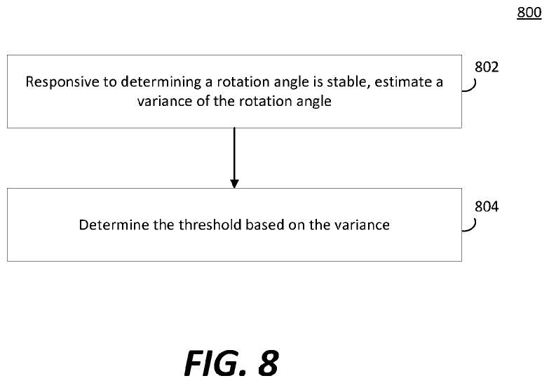

FIG. 8 is a flowchart of an example process for determining a threshold used to recenter a reference axis in accordance with some embodiments.

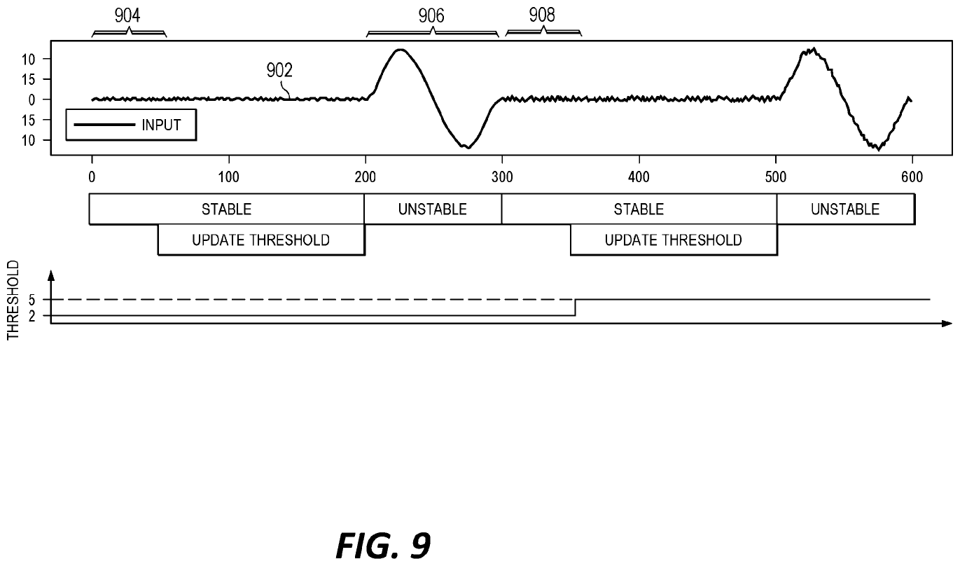

FIG. 9 is a graph of example sensor data that may be used to determine a threshold used to recenter a reference axis in accordance with some embodiments.

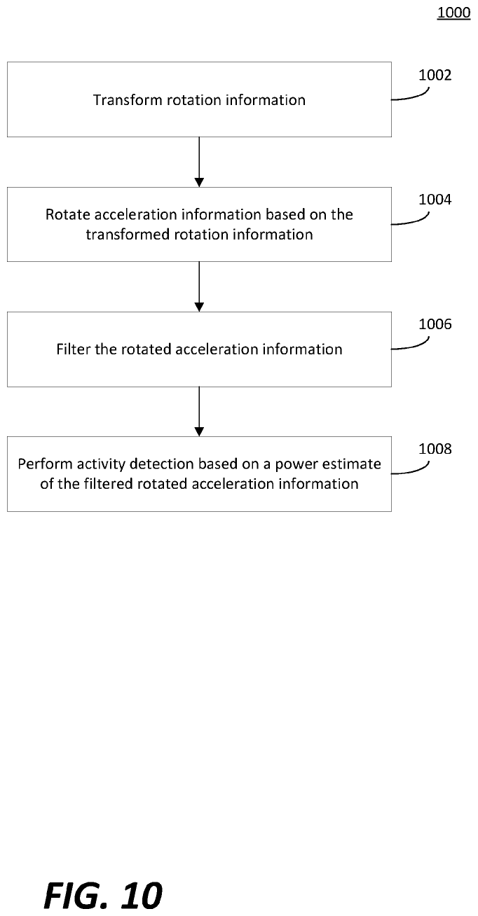

FIG. 10 is a flowchart of an example process for performing activity detection in accordance with some embodiments.

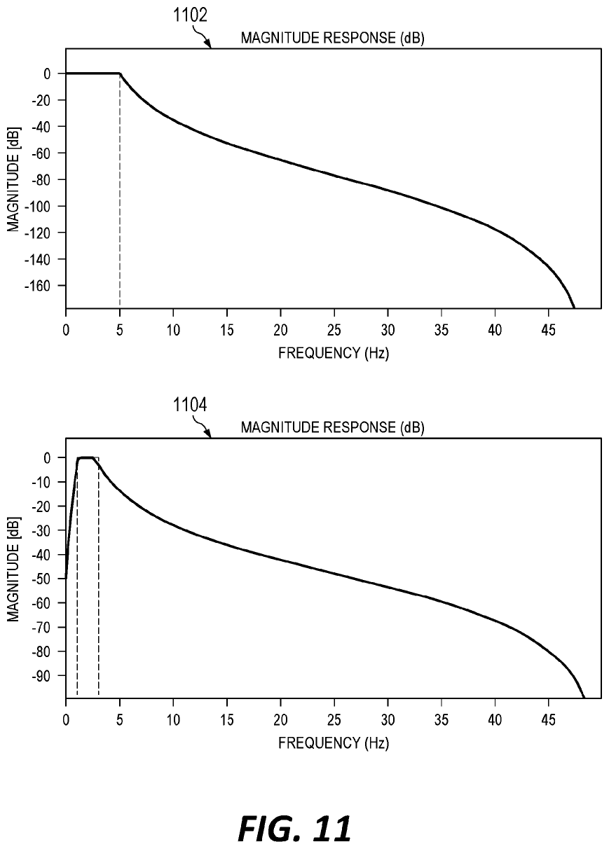

FIG. 11 depicts graphs of example filters that may be applied to motion data for performing activity detection in accordance with some embodiments.

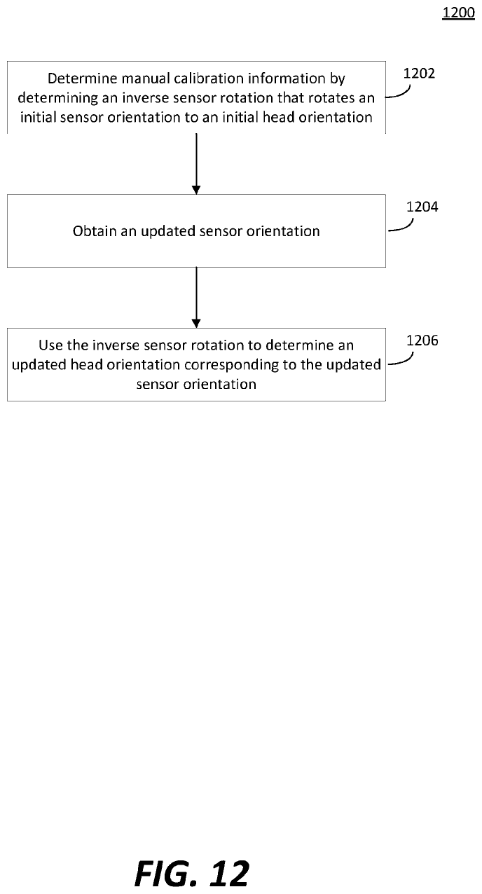

FIG. 12 is a flowchart of an example process for calibrating motion data in accordance with some embodiments.

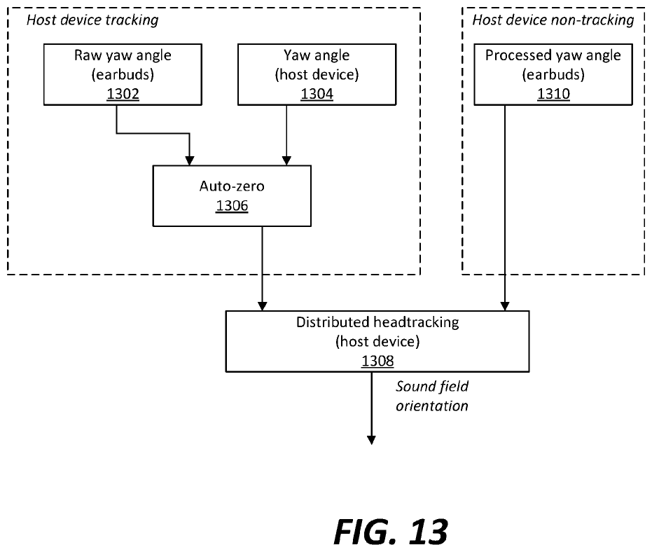

FIG. 13 depicts an example configuration for utilizing host device orientation for determining sound field orientation in accordance with some embodiments.

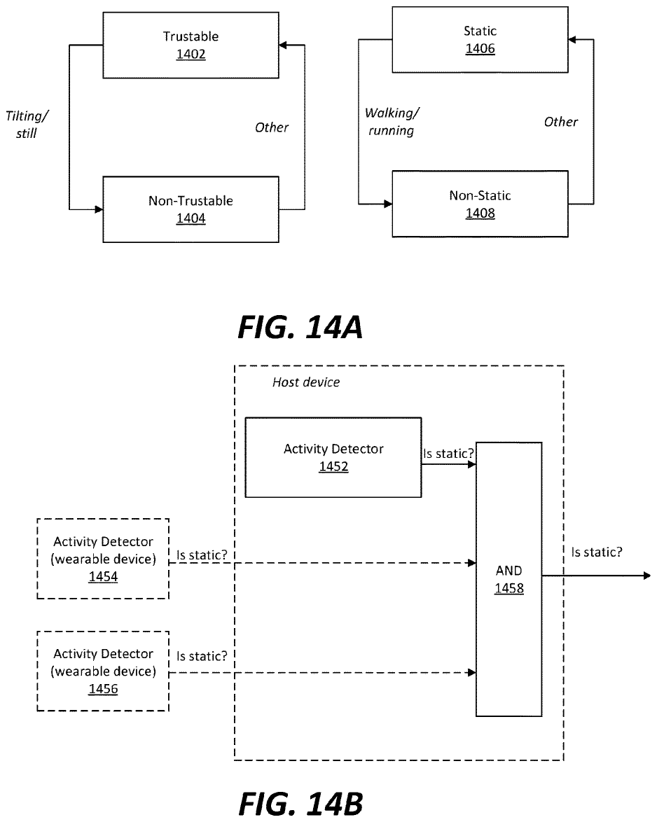

FIG. 14A depicts example state machines for determining whether data is trustable and/or static in accordance with some embodiments.

FIG. 14B depicts a diagram for determining whether an orientation is static in accordance with some embodiments.

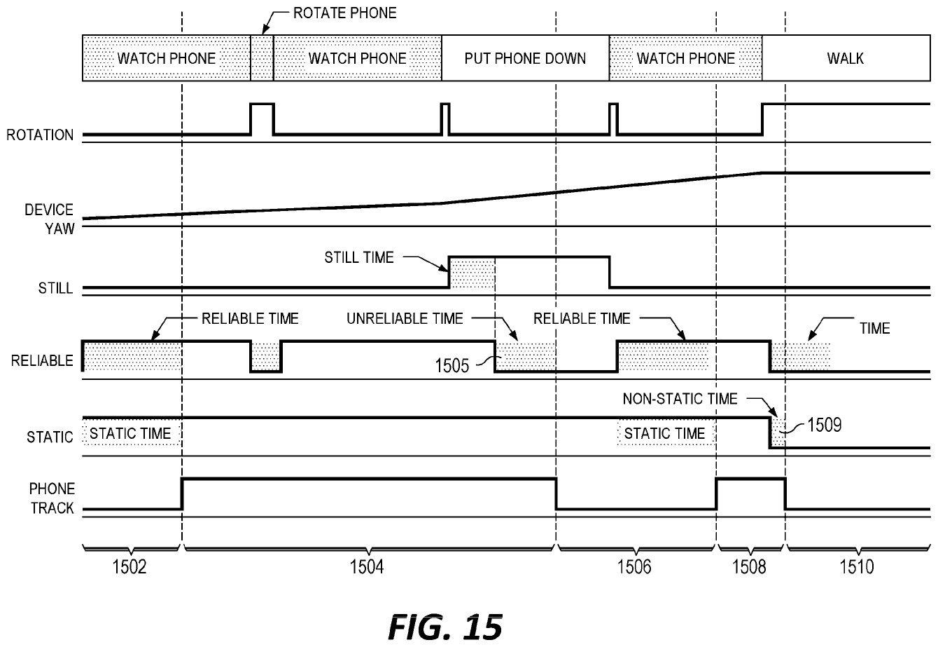

FIG. 15 is a graph of example host device tracking states in accordance with some embodiments.

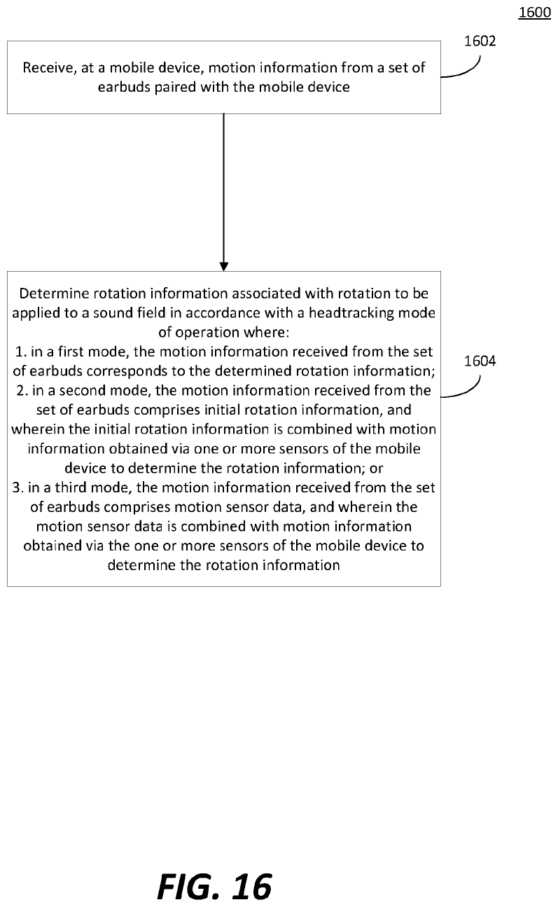

FIG. 16 is a flowchart of an example process for determining rotation information by a mobile device in accordance with a headtracking mode of operation in accordance with some embodiments.

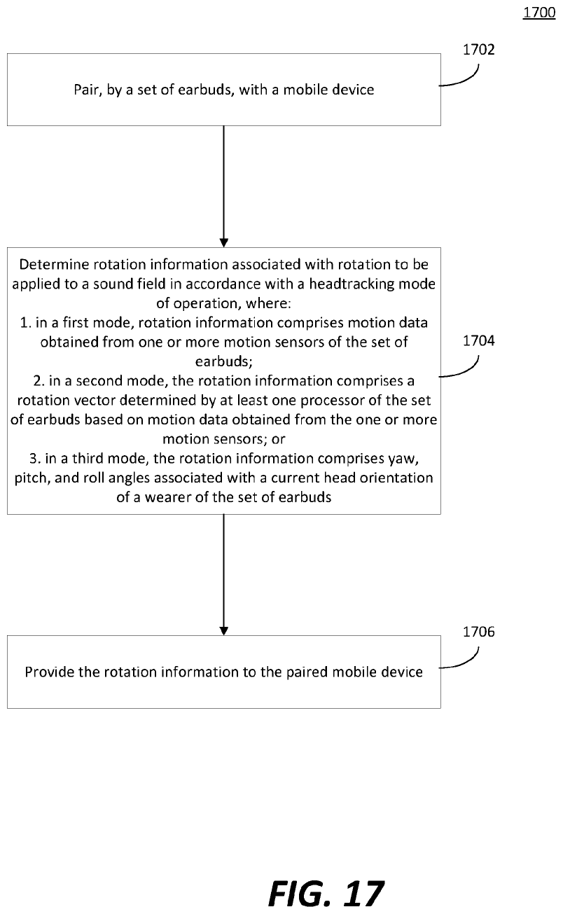

FIG. 17 is a flowchart of an example process for determining rotation information by a set of earbuds in accordance with a headtracking mode of operation in accordance with some embodiments.

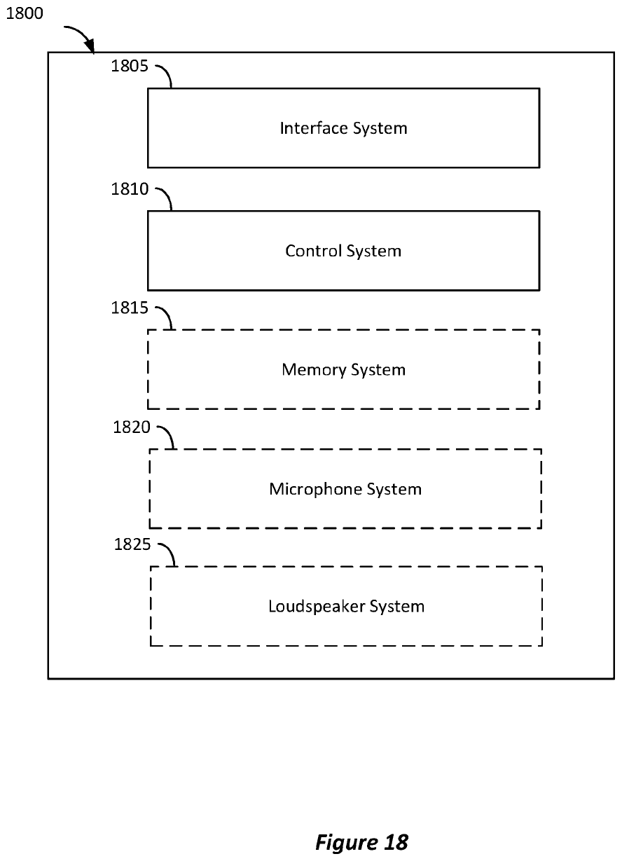

FIG. 18 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

In some cases, audio content may be rendered in an immersive manner such that audio content objects are rendered as having particular spatial locations with respect to a listener's head. In cases in which a listener is wearing headphones or earbuds, the audio content may be rendered based on the listener's head orientation, which may be determined based on one or more sensors disposed in or on the headphones or earbuds. For example, the sensors may include one or more accelerometers and/or one or more gyroscopes, which may provide sensor data that may be used to determine the listener's head orientation and/or changes in the listener's head orientation. Based on the listener's head orientation, audio content may be rendered such that the spatial locations of audio objects are perceived at particular locations with respect to the listener's head orientation. For example, in some cases, it may be desirable to render an audio object as being in front of the listener, regardless of the direction the listener is facing. As another example, it may be desirable to render an audio object at a fixed location with respect to an external reference frame regardless of the direction the listener's head is oriented. In some cases, whether an audio object is rendered with a spatial location that is fixed relative to an external frame of reference or with respect to a frame of reference centered on the listener's head may depend on the type of audio content, the activity the listener is engaged in, or the like.

Data from headphones or earbuds may be provided to a host device (e.g., a mobile device, a tablet computer, etc.) via a communication channel, such as a BLUETOOTH communication channel or other type of communication channel. The host device may render audio content based on the data and cause the rendered audio content to be presented via the headphones/earbuds. Note that, as used herein, a “host device” generally refers to a device that is communicatively coupled with a set of earbuds and which renders audio content to be presented by the set of earbuds. Examples of host devices include mobile phones, tablet computer, laptop computer, desktop computers, game consoles, or the like. Different headphones/earbuds and different host devices may have different capabilities. For example, some headphones/earbuds may be equipped with both accelerometers and gyroscopes, whereas other headphones/earbuds may only have one or type of sensor (e.g., one or more gyroscopes). As another example, some headphones/earbuds may have more sophisticated processors capable of more sophisticated processing to determine a listener's current activity and/or head orientation, whereas other headphones/earbuds may have more limited processing capabilities.

Disclosed herein are systems, methods, and techniques for flexibles modes of performing listener headtracking and determining sound field orientation for earbuds, host device, and other wearable devices having differing capabilities. In particular, disclosed herein are various configurations for a distributed headtracking system in which distributed headtracking block instances may be implemented on a set of earbuds and a paired host device. Each distributed headtracking block instance may be configured to perform various functions, dependent on sensors disposed on each device, capabilities of each device, operating system requirements or limitations of the device, etc. For example, a distributed headtracking block instance implemented on a set of earbuds may be configured to provide rotation information to a host device via a BLUETOOTH communication channel or other communication channel, where the particular rotation information provided by the set of earbuds may be dependent on capabilities of the set of earbuds. The host device may be configured to combine the rotation information provided by the set of earbuds with rotation information and/or motion data obtained by sensors of the host device to determine aggregate rotation information, which may in turn be used by the host device to determine a sound field orientation or rotation according to which the audio content may be rendered. In some embodiments, an additional wearable device, such as a smart watch or fitness tracker, may additionally include a distributed headtracking block instance, which may be configured to provide additional motion data associated with a listener to the host device. In such embodiments, the host device may utilize the additional motion data to determine listener orientation or listener activity (e.g., whether the listener is walking/running, substantially static, etc.).

In some embodiments, a distributed headtracking system may be implemented such that a host device (e.g., a mobile device, a laptop computer, etc.) implements an instance of a distributed headtracking block and one or more paired wearable devices (e.g., a set of earbuds, a fitness tracker, a smart watch, etc.) implement instances of a distributed headtracking block. Each distributed headtracking block instance may be configured to take, as an input, motion data, which may include acceleration data and/or raw rotation data (e.g., from a gyroscope), and generate rotation information as an output. The rotation information may be in the format of a rotation vector or rotation matrix, a quaternion, or yaw-pitch-roll angles (e.g., Euler angles). The host device may receive rotation information from the one or more paired devices and may generate aggregated rotation information based on rotation information generated from the host device's sensors and rotation information generated from the sensors of the one or more paired devices. The aggregated rotation information may then be used to determine a sound field orientation based on which audio content is to be rendered. Note that, regardless of the device each distributed headtracking instance is implemented, a distributed headtracking instance, and any blocks or modules implemented therein, may be implementing using one or more control systems and/or one or more processors of the device. An example of such a control system is shown in and described below in connection with FIG. 18.

FIG. 1A illustrates an example implementation of a distributed headtracking system that includes distributed headtracking block instances on a host device and on paired devices in accordance with some embodiments. As illustrated, a first wearable device 101 includes device sensor(s) 102 and a distributed headtracking instance 104. Device sensor(s) 102 may include one or more accelerometers and/or one or more gyroscopes configured to provide raw rotation data and/or raw acceleration data to distributed headtracking instance 104. Distributed headtracking instance 104 may be configured to provide rotation information that fuses the acceleration data and the raw rotation data provided by device sensor(s) 102 to distributed headtracking instance 112 of host device 105. Similarly, a second wearable device 103 also includes device sensor(s) 106 and a distributed headtracking instance 108. Distributed headtracking instance 108 may also be configured to provide rotation information to distributed headtracking instance 112 of host device 105. In some embodiments, first wearable device 101 may be a set of earbuds paired with the host device, and second wearable device 103 may be, e.g., a fitness tracker, a smart watch, a pair of smart glasses, an augmented reality headset, or the like. Host device 105 includes device sensor(s) 110, which may be configured to provide raw rotation data and acceleration data to distributed headtracking instance 112. Host device 105 may be a mobile phone, a tablet computer, or the like. As illustrated, distributed headtracking instance 112 may aggregate rotation information provided by each of distributed headtracking instance 104 and distributed headtracking instance 108, in conjunction with rotation data and acceleration data from device sensor(s) 110 of the host device to generate output rotation. The output rotation may be usable to determine a sound field orientation or rotation based on which audio content is rendered by the host device. Note that, although two wearable devices are illustrated in FIG. 1, in some embodiments, a distributed headtracking system may utilize one, two, three, five, etc. wearable devices. For example, in some embodiments, a set of earbuds paired with a host device may be utilized, and the second wearable device may be omitted.

In some embodiments, wearable devices, such as a set of earbuds, a fitness tracker, a smart watch, etc., may not implement instances of a distributed headtracking block. In some such implementations, a wearable device may provide raw rotation data (e.g., from a gyroscope) and/or acceleration data (e.g., from one or more accelerometers) to a distributed headtracking block instance of the host device. The host device may then determine output rotation information from which a sound field orientation may be determined based on an aggregation of the raw data from the wearable device(s) and sensor data of the host device.

FIG. 1B illustrates an example implementation of a distributed headtracking system in which a distributed headtracking instance is implemented solely on a host device in accordance with some embodiments. As illustrated, a first wearable device 151 includes device sensor(s) 152 configured to provide raw rotation data and acceleration data to a distributed headtracking instance 158 of a host device 155. Similarly, a second wearable device 153 includes device sensor(s) 154 configured to provide raw rotation data and acceleration data to distributed headtracking instance 158 of host device 155. Distributed headtracking instance 158 is configured to utilize the raw rotation data and acceleration data from each of first wearable device 151 and second wearable device 153 in conjunction with raw rotation data and acceleration data from device sensor(s) 156 of host device 155 to determine output rotation values. The output rotation values from host device 155 may then be used to determine a sound field orientation or rotation according to which audio content may be rendered by host device 155.

In some embodiments, a final output rotation may include yaw-pitch-roll (YPR) angles, sometimes referred to herein as Euler angles. The YPR angles may be used to determine a sound field orientation or rotation based on which audio content may be rendered by a host device and played back by a paired set of earbuds. The YPR angles may be determined by a distributed headtracking block instance. In some embodiments, the distributed headtracking block instance that determines YPR angles may be implemented on the host device. Alternatively, in some embodiments, the distributed headtracking block instance that determines YPR angles may be implemented on a set of earbuds paired with the host device and transmitted to the host device such that audio content may be rendered by the host device in accordance with the YPR angles.

FIGS. 2A, 2B, 2C, 2D, and 2E illustrate various example configurations of distributed headtracking systems in accordance with some embodiments.

In the example configuration illustrated in FIG. 2A, a distributed headtracking block instance 202 on a set of earbuds receives accelerometer and gyroscope data and generates, as an output, a rotation vector. The rotation vector may include a fusion of acceleration and raw rotation data generated by the accelerometer and gyroscope, respectively. The rotation vector may be provided to a distributed headtracking block instance 204 on a host device. Distributed headtracking block instance 204 may combine the rotation vector with quaternion information (which may be generated based on one or more accelerometers and/or gyroscopes of the host device) to generate output YPR angles. Note that the host device may also receive gyroscope data, as illustrated in FIG. 2A.

In the example configuration illustrated in FIG. 2B, a distributed headtracking block instance 208 of a host device may receive acceleration and raw rotation data from earbuds 206. Note that earbuds 206 may be configured to transmit the raw acceleration and raw rotation data without processing the data to generate, e.g., a rotation vector or a rotation matrix. Distributed headtracking block instance 208 may be configured to combine the acceleration data and raw rotation data from earbuds 206 with quaternion information obtained from sensors of the host device to generate output YPR angles.

In the example configuration illustrated in FIG. 2C, a distributed headtracking block instance 210 of a set of earbuds may be directly configured to generate output YPR angles based on gyroscope data from one or more gyroscopes of the set of earbuds.

In the example configuration illustrated in FIG. 2D, a distributed headtracking block instance 212 of a set of earbuds may be configured to generate a rotation vector based on acceleration data and raw rotation data from one or more accelerometers and one or more gyroscopes, respectively. A distributed headtracking block instance 214 of a wearable device (e.g., a smart watch, a fitness tracker, etc.) may be configured to generate motion state data from one or more accelerometers of the wearable device. A distributed headtracking block instance 216 of a host device may be configured to combine the rotation vector received from the set of earbuds with motion state data received from the wearable device, in conjunction with quaternion data generated from sensors of the host device to generate the output YPR angles. Note that, as illustrated in FIG. 2D, the host device may additionally receive gyroscope data from the set of earbuds.

In the example configuration illustrated in FIG. 2E, a set of earbuds may implement an auto-zero block 218 configured to transform gyroscope data (e.g., raw rotation data) to a rotation vector. The rotation vector may then be transmitted to a distributed headtracking block instance 220 of a host device. Distributed headtracking block instance 220 of the host device may be configured to combine the rotation vector received from the set of earbuds with quaternion data generated based on sensors of the host device to generate the output YPR angles.

In some implementations, a distributed headtracking block instance, regardless of the device it is implemented on, may be configured to perform any combination of functions, including transforming rotation data from one format to another, calibration of rotation data, performing activity detection, re-centering a reference frame based on user orientation and/or movement, and/or generating rotation information. In some embodiments, a distributed headtracking block instance implemented on a set of earbuds may be configured to determine a walking direction, e.g., by performing signal processing on acceleration data obtained from one or more accelerometers of the set of earbuds. Note that flexible implementations of distributed headtracking block instances may allow each device to generate data based on capabilities of the device.

FIG. 3 is a schematic diagram of an example implementation of a distributed headtracking block instance 300 implemented on a set of earbuds. As illustrated, a transform block 302 may be configured to take, as input, raw rotation data obtained from e.g., one or more gyroscopes of the set of earbuds. The raw rotation data may be transformed by transform block 302 to any suitable format, such as a rotation vector, a rotation matrix, quaternions, etc. The transformed rotation data may optionally be provided to calibration block 304, which may be configured to calibrate the rotation data. Example techniques that may be implemented by calibration block 304 are shown in and described below in connection with FIG. 12.

Acceleration data, obtained from one or more accelerometers of the set of earbuds, may be optionally provided to a walking direction detection block 306. Walking detection direction block 306 may utilize rotation data and acceleration data to determine a walking direction, e.g., by performing signal processing to determine a walking direction. Activity detection block 308 may utilize the acceleration data to detect whether the user is still or engaged in an activity based on signal processing of the acceleration data. Example techniques that may be implemented by activity detection block 308 are shown in and described below in connection with FIGS. 10 and 11. The transformed rotation data, which may optionally be calibrated, may be provided to auto-zero block 310, which may be configured to re-center a reference axis based on user rotation data. Example techniques that may be implemented by auto-zero block 310 are shown in and described below in connection with FIGS. 6, 7, 8, and 9. Based on the re-centered reference axis, output selector block 312 may be configured to output rotation information, which may include a rotation vector, YPR angles, or the like, dependent on a headtracking mode of operation and/or capabilities of the set of earbuds. The output rotation information may be transmitted to a paired host device (e.g., a paired mobile phone).

FIG. 4 is a schematic diagram of an example implementation of a distributed headtracking block instance 400 implemented on a wearable device other than a set of earbuds. For example, distributed headtracking block instance 400 may be implemented on a fitness tracker, a smart watch, an augmented reality headset, etc. As illustrated, distributed headtracking block instance 400 may include a transform block 402 configured to take, as an input, raw rotation data (e.g., obtained from a gyroscope), and transform the raw rotation data to, e.g., a rotation vector, a rotation matrix, quaternions, etc. The transformed rotation data may be provided to activity detection block 404. Activity detection block 404 may be configured to utilize the transformed rotation data and acceleration data to perform activity detection. Example techniques that may be implemented by activity detection block 308 are shown in and described below in connection with FIGS. 10 and 11. The output rotation information from distributed headtracking block instance 400 may be provided to a host device.

FIG. 5 is a schematic diagram of an example implementation of a distributed headtracking block instance 500 implemented on a host device in accordance with some embodiments. As illustrated, distributed headtracking block instance 500 is configured to receive raw rotation data and acceleration data from a set of paired earbuds 502 and, optionally, from another wearable device 504. The rotation data from the set of earbuds may be transformed by transformation block 506, e.g., to a rotation vector or matrix, quaternions, or the like. The transformation rotation data may then be calibrated by calibration block 508. The calibrated rotation data may then be used by auto-zero block 512 to determine a re-centered reference axis. The calibrated rotation data and the acceleration data from the earbuds may be processed by activity detection block 514a to determine a motion state based on the earbud data. Rotation data and acceleration data from the optional wearable device may processed by activity detection block 514b to determine a motion state based on data from the wearable device. Data from host device sensors 510 may be processed by activity detection block 514c to determine a motion state based on the host device sensor data. Note that example techniques that may be implemented by any of activity detection blocks 514a, 514b, and/or 514c are shown in and described below in connection with FIGS. 10 and 11. The motion states determined by the earbud data, the optional wearable device data, and the host device sensor data, in conjunction with the re-centered reference axis, may be processed by core host device tracker block 516 to determine the output rotation, which may be output YPR angles.

In some embodiments, a reference coordinate system may be updated using what is sometimes referred to herein as an “auto-zero procedure.” The reference coordinate system may be updated if, e.g., a listener moves or changes orientation, thereby allowing the sound field to be rotated in accordance with the listener's updated reference coordinate system. The reference axis may be updated based on rotation data. For example, in some implementations, the reference axis may be updated responsive to a determination that a fluctuation in rotation data is below a threshold for a predetermined duration of time. In response, the reference axis may be updated to a new reference axis, e.g., using a cross-fading technique or other smoothing technique to allow for updating the reference axis without provoking a jarring listener experience. For example, cross-fading may be implemented using a linear smoothing technique, an exponential smoothing technique, a cosine-like smoothing technique, or the like. In some embodiments, the new reference axis may be determined based at least in part on user activity. For example, the new reference axis may be set as a listener walking direction responsive to a determination that the listener is walking in a single, linear direction. As another example, the new reference axis may be set as a short-time smoothed input orientation responsive to determining that the listener is in motion but their movement is not in a single direction.

FIG. 6 is a flowchart of an example process 600 for updating a reference axis in accordance with some embodiments. Blocks of process 600 may be implemented on a host device, such as a mobile phone, configured to update a sound field orientation based on the reference axis. In some embodiments, blocks of process 600 may be executed in an order other than what is shown in FIG. 6. In some implementations, two or more blocks of process 600 may be executed substantially in parallel. In some implementations, one or more blocks of process 600 may be omitted.

Process 600 may begin at 602 by determining a transformation of rotation information to generate yaw, pitch, and roll angles. The rotation information may be obtained by one or more sensors of a set of earbuds paired with a host device, one or more sensors of another wearable device paired with the host device, and/or one or more sensors of the host device. The one or more sensors may include one or more accelerometers, one or more gyroscopes, etc.

At 604, process 600 may smooth the yaw, pitch, and roll angles. Smoothing may be performed over any suitable time window, e.g., ten milliseconds, fifty milliseconds, half a second, one second, or the like.

At 606, process 600 may determine a fluctuation in the smoothed yaw, pitch, and roll angles. In some embodiments, the fluctuation may be determined by:

$${θ}_{fluc} = θ [ t 0 ] - {\sum }_{n = t 0}^{t 0 - N} \frac{θ [ n ]}{( N + 1 )}$$

In the equation given above, θ[t0] represents the current angle, and N+1 represents the window length for calculation of the mean.

At 608, responsive to the yaw, pitch, and roll fluctuation being greater than a predetermined threshold and determined to be stable, process 600 may determine an updated reference axis. In some embodiments, the threshold may be determined based on the data variance, as shown in and described below in connection with FIGS. 8 and 9. In such implementations, the variance may be estimated from portions of the rotation data where the rotation angle is stable for a given period of time. Alternatively, in some embodiments, the threshold may be set as a predetermined constant value.

Process 600 may determine that the yaw, pitch, and roll fluctuation is stable by utilizing a counter to count the time duration that the fluctuation is less than the threshold. In some embodiments, responsive to determining that the counter has reached the specified time duration (generally represented herein as T_{stable}), process 600 may determine the updated reference axis. The updated reference axis may be determined based on the yaw, pitch, and roll angles, based on the listener's current activity, or any combination thereof.

At 610, process 600 can transition to the updated reference axis. For example, process 600 can cross-fade from the current reference axis to the updated reference axis. As a more particular example, a cross-fade may be implemented using a linear transition, an exponential transition, a cosine-like transition, or the like.

FIG. 7 illustrates a graph of rotation angle 702. As illustrated, responsive to rotation angle 702 being less than a predetermined fluctuation threshold 704 for a predetermined duration of time 706 (represented as “stable time”), the reference axis angle (represented by curve 708) is transitioned to the updated reference axis. The transition occurs over what is represented as “re-centering time” in FIG. 7.

As described above in connection with FIG. 6, in some implementations, the threshold for re-centering a reference axis may be set based on a variance of the rotation angle. For example, in some embodiments, the threshold may be proportional to the variance. The variance may be determined for a portion of rotation angle data that is determined to be stable. FIG. 8 is a flowchart of an example process 800 for setting a threshold used to re-center the reference axis in accordance with some embodiments. In some embodiments, blocks of process 800 may be executed by one or more control systems and/or processors (e.g., the control system shown in and described below in connection with FIG. 18) of a host device and/or a set of earbuds. In some embodiments, blocks of process 800 may be executed in an order other than what is shown in FIG. 8. In some implementations, two or more blocks of process 800 may be executed substantially in parallel. In some implementations, one or more blocks of process 800 may be omitted.

Process 800 can begin at 802 by estimating a variance of a rotation angle response to determining the rotation angle is stable. For example, process 800 may determine that the rotation angle has been within a predetermined range for more than a predetermined time period to determine the rotation angle is stable. The variance may be determined based on a time series of rotation angle data. In some embodiments, the variance may be referred to herein as a fluctuation of the rotation angle.

At 804, process 800 can determine the threshold at which to re-center the reference axis based on the variance. For example, in some embodiments, the threshold may be determined by:

$$T = α {VT}_{c}$$

In the equation given above, a represents a constant, V represents the variance of the rotation angle, and T_{c} represents an input constant threshold. In some examples, a may have a value that is larger than 1/V when the user is determined to be stable. Example values of a may include 9, 10, 11, or the like. Example values for T_{c} may include 5 degrees, 10 degrees, 15 degrees, or the like.

FIG. 9 is a graph of example rotation angle depicted by curve 902 and time periods over which the rotation angle is stable and unstable. As illustrated, during time period 904, the rotation angle is stable for a predetermined time period. Responsive to the rotation angle being stable for the predetermined time period, the threshold is updated based on the variance of the rotation angle during time period 904. During time period 906, the rotation angle is unstable. During time period 908, the rotation angle is stable for the predetermined time period. Responsive to the rotation angle being stable for the predetermined time period, the threshold is updated based on the variance of the rotation angle during time period 908. Note that the variance of the rotation angle is greater during time period 908 than for time period 904, and accordingly, the threshold is higher after the update after time period 908 than after the update after time period 904.

In some implementations, one or more control systems or processors of a set of earbuds and/or a mobile device may be configured to perform activity detection on motion data obtained from motion sensors (e.g., one or more accelerometers and/or gyroscopes) of the set of earbuds. For example, the activity detection may indicate whether the listener is walking/running, or is static. In some embodiments, a sound field orientation in instances in which the listener is walking or running may be set to be the direction the listener is moving in, whereas the sound field orientation may be set to be the direction the listener is looking (e.g., head orientation direction) if the listener is determined to be static (e.g., not moving forward in a linear direction). In some embodiments, activity detection may be performed by filtering acceleration data, e.g., acceleration data in the z-direction corresponding to acceleration of the listener's head along the axis pointing out of the top of the listener's head. For example, the acceleration data may be low-pass and/or bandpass filtered. Continuing with this example, the power of the filtered acceleration data may be compared to a threshold. The listener may be determined to be walking or running responsive to the power estimate exceeding a predetermined threshold. Conversely, the listener may be considered to be static responsive to the power estimate being below the predetermined threshold.

FIG. 10 is a flowchart of an example process 1000 for performing activity detection in accordance with some embodiments. Blocks of process 1000 may be executed by a control system and/or a processor of a set of earbuds and/or a wearable device. An example of such a control system is shown in and described below in connection with FIG. 18. In some embodiments, blocks of process 1000 may be executed in an order other than what is shown in FIG. 10. In some implementations, two or more blocks of process 1000 may be executed substantially in parallel. In some implementations, one or more blocks of process 1000 may be omitted.

Process 1000 can begin at 1002 by transforming rotation information. For example, the rotation information may correspond to raw gyroscope data, which may be transformed to rotation information, generally represented herein as matrix M.

At 1004, process 1000 can rotate acceleration information based on the transformed rotation information. For example, the rotation data may correspond to three-axis rotation data, generally represented herein as aₓ, a_{y}, and a_{z}. Continuing with this example, the acceleration data may be rotated by multiplying the acceleration data by the rotation matrix M. By way of example, rotated acceleration information may be determined by:

$$[ \begin{matrix}\overline{{a}_{x}} \\ \overline{{a}_{y}} \\ \overline{{a}_{z}}\end{matrix} ] = M [ \begin{matrix}{a}_{x} \\ {a}_{y} \\ {a}_{z}\end{matrix} ]$$

At 1006, process 1000 can filter the rotated acceleration information. For example, in some embodiments, process 1000 can filter the rotated z-axis acceleration information, represented above as a̅_̅{̅z̅}̅. In some embodiments, filtering may involve applying a lowpass filter (e.g., with a 3 Hz cutoff, a 5 Hz cutoff, a 7 Hz cutoff, etc.), followed by bandpass filtering the signal. The bandpass filter may have cutoff frequencies within a range of about 1-5 Hz, 2-3 Hz, or the like. Such filtering may serve to isolate portions of the z-axis acceleration signal related to the up and down motion of a listener's head when walking or running.

FIG. 11 illustrates an example lowpass filter 1102 and an example bandpass filter 1104 in accordance with some embodiments.

Referring back to FIG. 10, at 1008, process 1000 can perform activity detection based on the filtered acceleration information. For example, process 1000 can generate a power estimate, generally represented herein as Pₘ. By way of example, the power estimate may be determined by:

$${P}_{m} = {\sum }_{t 0}^{t 1} \text{?}$$

In the equation given above, [symbol] represents the filtered and rotated z-axis acceleration information, to is an initial time, and t₁ represents the current time. The duration between t₁ and t₀ may be a time duration that spans about 10 samples (e.g., 8 samples, 10 samples, 12 samples, etc.). In on example, given a 50 Hz sampling rate and a time duration that spans 10 samples, the time duration is 200 milliseconds.

In some embodiments, process 1000 can determine whether the current activity is walking or running, or static by comparing the power estimate to a predetermined threshold, generally represented herein as Tₘ. For example, process 1000 can determine the listener is walking or running responsive to the power estimate meeting or exceeding Tₘ. Conversely, process 1000 can determine the listener is static responsive to the power estimate being below Tₘ. In some embodiments, Tₘ may have a value between 0.02 and 0.3, for example, 0.05, 0.1, 0.15, 0.25, or the like.

In some instances, an earbud of a set of earbuds may be tilted within the listener's ear, which may in turn make determining listener head orientation difficult due to the tilt of sensors within the earbud. In some embodiments, the tilt may be compensated for in determining an orientation of the listener's head. For example, in some embodiments, a calibration procedure may be performed which determines an inverse rotation to be performed to rotate from a sensor-measured orientation to a known initial head orientation. The inverse rotation determined during the calibration procedure may then be stored for future use, e.g., to compensate for a tilt of the earbud with the listener's ear when being worn by the listener.

FIG. 12 is a flowchart of an example process 1200 for performing and utilizing a calibration procedure to compensate for earbud tilt in accordance with some embodiments. In some implementations, blocks of process 1200 may be executed by one or more control systems or processors of a set of earbuds and/or a mobile device paired with the set of earbuds. An example of such a control system is shown in and described below in connection with FIG. 18. In some embodiments, blocks of process 1200 may be performed in an order other than what is shown in FIG. 12. In some implementations, two or more blocks of process 1200 may be performed substantially in parallel. In some implementations, one or more blocks of process 1200 may be omitted.

Process 1200 can begin at 1202 by determining manual calibration information by determining an inverse sensor rotation that rotates an initial sensor orientation to an initial head orientation. The initial head orientation may be a known head orientation, e.g., with the listener's head pointed straight ahead and/or at a neutral angle. In some embodiments, the initial head orientation may be represented by an initial quaternion of the head, generally represented herein as qₕ₀. In some instances, qₕ₀ may be represented by [1, 0, 0, 0]. The initial sensor orientation may be represented by the sensor measured quaternion qₛ₀. The inverse sensor rotation may be represented by q′ₛ₀, which may be determined such that the rotation by q′ₛ₀ rotates the initial sensor orientation to the initial head orientation, e.g., qₛ₀ is rotated to qₕ₀ by multiplication of qₛ₀ by q′ₛ₀. Note that the inverse sensor rotation may be stored (e.g., in memory associated with the earbuds and/or the mobile device) for future use.

At 1204, process 1200 can obtain an updated sensor orientation. The updated sensor rotation may be obtained at any suitable time after the manual calibration has been performed, e.g., hours, days, weeks, months, years, etc. later. The updated sensor orientation may be obtained from one or more sensors of the set of earbuds (e.g., one or more accelerometers, one or more gyroscopes, etc.). The updated sensor orientation is generally represented herein as qₛ₁.

At 1206, process 1200 can use the inverse sensor rotation to determine an updated head orientation corresponding to the updated sensor orientation. For example, in some embodiments, process 1200 can multiply the inverse sensor rotation by the updated sensor orientation to determine the updated head orientation. By way of example, given an inverse sensor rotation of q′ₛ₀ and an updated sensor rotation represented by qₛ₁, the updated head orientation, represented by qₕ₁ may be determined by:

$${q}_{h 1} = {q}_{s 1} \times {q}_{s 0}^{′}$$

In some cases, it may be advantageous to determine a sound field orientation based on the orientation of a host device that is presenting content. For example, in an instance in which a listener is viewing video content presented from the host device (e.g., viewing a video on a phone or tablet computer), the sound field orientation may be determined with reference to the display of the host device. As another example, in an instance in which the host device is in a moving vehicle, the host device orientation of movement and/or orientation may represent the orientation of the environment, and accordingly, the sound field orientation may be determined to align with the host device orientation. In general, determining sound field orientation based on the host device orientation is referred to herein as “a host device tracking state,” whereas instances in which the sound field orientation is determined based on the listener head orientation as determined by sensors of the earbuds is referred to as “a host device non-tracking state.” In the “host device tracking state,” the host device may be configured to combine orientation information obtained from the earbuds with rotation information determined from the host device to determine an overall orientation. For example, yaw angles obtained from the earbuds and from the host device may be combined to determine a single sound field orientation yaw angle.

FIG. 13 is a diagram of an example system for determining a sound field orientation in either a host device tracking state or a host device non-tracking state in accordance with some embodiments. As illustrated, in a host device tracking state, a raw yaw angle 1302 from earbuds and a yaw angle 1304 from the host device may be combined by an auto-zero block 1306. Auto-zero block 1306 may be configured to determine a yaw angle between the raw yaw angle from the earbuds and the yaw angle from the host device. The output of auto-zero block 1306 may be provided to distributed headtracking block 1308 on the host device, which may be configured to determine a sound field orientation based on the yaw angle determined by auto-zero block 1306.

In contrast, in the host device non-tracking state, a processed yaw angle 1310 obtained from sensors of the earbuds may be provided to distributed head tracking block 1308 on the host device, which may determine a sound field orientation irrespective of an orientation of the host device.

In some embodiments, the host device tracking state may be entered responsive to a necessary condition of the host device orientation data being trustable and responsive to a sufficient condition of the listener activity being static (e.g., not walking or running). In other words, the host device tracking state is only entered if the host device orientation data is trustable, but may not be entered even if the orientation data is trustable. A determination of the listener activity being static is sufficient to cause the host device tracking state to be entered. The host device orientation data may be considered trustable responsive to a determination that the host device is neither tilting nor is still (e.g., due to being left unattended, for example, on a table or desk). A determination of the listener activity being static (e.g., not walking or running) may be determined based on an agreement based on data from one or more devices (e.g., the host device, the set of earbuds, another paired wearable device, etc.) that the listener is static. Note that transition to a host device tracking state may occur after the host device orientation data has been determined to be trustable for more than a threshold reliability time, and/or after the listener activity is determined to be static for more than a threshold static movement time. Using threshold state times to govern transition to a host device tracking state may prevent momentary state switches, which may lead to jarring sound field orientations for the listener.

FIG. 14A illustrates state machines for transitioning between a trustable and a non-trustable state and for transitioning between a static and a non-static state in accordance with some embodiments. Note that determination of a state may be performed by one or more control systems and/or processors of a host device. An example of such a control system is shown in and described below in connection with FIG. 18.

A transition from a trustable state 1402 to a non-trustable state 1404 may occur responsive to a determination that the device is tilting or still. Conversely, a transition from the non-trustable state 1404 to the trustable state 1402 may occur responsive to a determination that the device is not tilting and is not still. A device may be determined to be tilting responsive to a determination that a tilting speed along the Z axis, generally represented herein as ω_{z} being greater than a threshold tilting speed, generally represented herein as ω_{z_threshold}. In some examples, ω_{z_threshold} may have a value of about 60 degrees, such as 55 degrees, 60 degrees, 65 degrees, or the like. The tilting speed may be determined based on a change in an angle between a current Z axis and a previous Z axis. Using quaternions, the angle with respect to the previous Z axis may be represented by:

$${θ}_{Z} = arccos ( {q}_{0}^{2} - {q}_{1}^{2} - {q}_{2}^{2} + {q}_{3}^{2} )$$

The tilting speed may be determined by:

$${ω}_{z} = \vert {θ}_{Z 0} - {θ}_{Z 1} \vert / t$$

In the equation given above, θ_{z0} represents the current angle with respect to the current Z axis, and θ_{z1} represents the previous angle with respect to the previous Z axis.

In some implementations, stillness may be determined based on the acceleration of the device through all three axes. For example, a stillness metric, represented herein as Pₛ may be determined by:

$${P}_{s} = \sqrt{{a}_{x}^{2} + {a}_{y}^{2} + {a}_{z}^{2}}$$

The host device may be determined to be still responsive to the stillness metric, Pₛ, being less than a predetermined stillness threshold.

Transition from a static state 1406 to a non-static state 1408 may occur responsive to a determination the listener is walking or running. Conversely, transition from the non-static state 1408 to the static state 1406 may occur responsive to a determination that the listener is not walking or running, or, that the listener is static. Note that detection of the listener walking or running may occur using an activity detection block executing on the host device, the set of earbuds, and/or another paired wearable device. Activity detection may be performed by filtering acceleration data along the Z axis, as shown in and described above in connection with FIG. 10.

In some implementations, a listener may be determined to be static based on output from activity detection blocks of one or more devices, including the host device, the set of earbuds, and/or another paired wearable device (e.g., a paired fitness tracker, a paired smart watch, etc.). FIG. 14B illustrates an example system for determining that a listener is static. As illustrated, an output of an activity detection block 1452 of a host device may generate an output that indicates whether or not the listener is static. Optionally, activity detection blocks 1454 and/or 1456 of other wearable devices (e.g., a set of earbuds, a smart watch, etc.) may generate outputs indicating whether or not the listener is static. For example, each activity block of each device may generate an output indicating a determination of whether the listener is static or not based on sensors (e.g., one or more accelerometers and/or gyroscopes) of each device. The static determinations may each be provided to an AND block 1458, which may generate an aggregate determination of whether the listener is static. For example, if each device that provides a determination of whether the listener is static is in agreement, AND block 1458 may generate an aggregate determination that the listener is static. Conversely, if the determination from multiple devices are not in agreement, AND block 1458 may generate an aggregate determination that the listener is not static.

FIG. 15 shows an example timing diagram that includes transitions from a host device tracking state to a host device non-tracking state in accordance with some embodiments. During time period 1502, the host device is in a non-tracking state. During time period 1502, the host device is determined to be both trustable (e.g., reliable) and static. After the threshold reliability time and the threshold static time have elapsed at the end of time period 1502, the host device transitions to the tracking state during time period 1504. During this time, the listener is watching their phone, as indicated. At the end of time period 1504, the host device orientation data enters an untrustable or unreliable state at time 1505, due to the host device being still for longer than a threshold stillness time. Responsive to the host device orientation data being untrustable for longer than the threshold reliability time, the host device enters the non-tracking state during time period 1506. During a portion of time period 1506, the listener begins watching their phone. During time period 1506, the host device orientation data is determined to be trustable and the host device is determined to be static for longer than the threshold reliability time and the threshold static time, respectively. Accordingly, the host device enters the tracking state during time period 1508. At the end of time period 1508, the listener begins to walk, which triggers the non-static state at time 1509. Responsive to the non-static threshold time being met, the host device enters the non-tracking state during time period 1510. Note that, as illustrated in FIG. 15, the non-static threshold time may be different than the threshold reliability time. For example, the threshold reliability time may be longer than the threshold non-static time.

FIG. 16 is a flowchart of an example process 1600 for determining rotation information usable to generate or modify a sound field orientation. Blocks of process 1600 may be performed by a one or more control systems and/or processors of a mobile device (sometimes referred to herein as a “host device”). An example of such a control system is shown in and described below in connection with FIG. 18. In some embodiments, blocks of process 1600 may be executed in an order other than what is shown in FIG. 16. In some implementations, two or more blocks of process 1600 may be executed in an order other than what is shown in FIG. 16. In some implementations, one or more blocks of process 1600 may be omitted. In some implementations, two or more blocks of process 1600 may be executed substantially in parallel.

Process 1600 can begin at 1602 by receiving, at the mobile device, motion information from a set of earbuds paired with the mobile device. As described above in connection with FIGS. 1A, 1B, and 2A-2E, the motion information may be raw rotation data and/or processed rotation data (e.g., a rotation vector or a rotation matrix). Optionally, the mobile device may additionally receive motion information from one or more other paired wearable devices, such as a paired fitness tracker, a paired smart watch, or the like.

At 1604, process 1600 can determine rotation information associated with a rotation to be applied to a sound field in accordance with a headtracking mode of operation. Note that the headtracking mode of operation may correspond to capabilities of the set of earbuds and/or host device, whether another wearable device is paired with the host device, or the like. For example, the headtracking mode of operation may correspond to a configuration of the distributed headtracking system as described above in connection with FIGS. 1A, 1B, and 2A-2E. For example, in a first mode, the motion information received from the set of earbuds corresponds to the determined rotation information. An example of the first mode is shown in and described above in connection with FIG. 2C. As another example, in a second mode, the motion information received from the set of earbuds comprises initial rotation information, and the initial rotation information is combined with motion information obtained via one or more sensors of the mobile device to determine the rotation information usable to rotate the sound field. Examples of the second mode are shown in and described above in connection with FIGS. 2A, 2D, and 2E. Note that, as described above, FIG. 2D illustrates a configuration of the second mode where motion information is additionally received from an additional paired wearable device. As yet another example, in a third mode, the motion information received from the set of earbuds comprises raw motion sensor data (e.g., from one or more accelerometers and/or gyroscopes), and the motion sensor data is combined with motion information obtained from one or more sensors of the mobile device to determine the rotation information usable to rotate the sound field. An example configuration in accordance with the third mode is shown in and described above in connection with FIG. 2B.

After determining the rotation information, the mobile device may be configured to rotate the sound field in accordance with the determined rotation information. The mobile device may then render audio content in accordance with the rotated sound field. The rendered audio content may then be presented via the paired earbuds.

FIG. 17 is a flowchart of an example process 1700 for determining rotation information usable to generate or modify a sound field orientation. Blocks of process 1700 may be performed by a one or more control systems and/or processors of a set of earbuds. An example of such a control system is shown in and described below in connection with FIG. 18. In some embodiments, blocks of process 1700 may be executed in an order other than what is shown in FIG. 17. In some implementations, two or more blocks of process 1700 may be executed in an order other than what is shown in FIG. 17. In some implementations, one or more blocks of process 1700 may be omitted. In some implementations, two or more blocks of process 1700 may be executed substantially in parallel.

Process 1700 can begin at 1702 by pairing, by the set of earbuds, with a mobile device. Pairing may cause audio content presented by the mobile device to be played back by the set of earbuds, cause motion data and/or rotation data to be transmitted by the set of earbuds to the mobile device via a communication channel, or the like. The communication channel between the set of earbuds and the mobile device may be a BLUETOOTH communication channel or other wireless communication channel.

At 1704, process 1700 can determine rotation information associated with a rotation to be applied to a sound field in accordance with a headtracking mode of operation. Note that the headtracking mode of operation may correspond to capabilities of the set of earbuds and/or host device, whether another wearable device is paired with the host device, or the like. For example, the headtracking mode of operation may correspond to a configuration of the distributed headtracking system as described above in connection with FIGS. 1A, 1B, and 2A-2E. For example, in a first mode, the rotation information may comprise motion data obtained from one or more motion sensors of the set of earbuds. An example configuration in accordance with the first mode is shown in and described above in connection with FIG. 2B. As another example, in a second mode, the rotation information may comprise a rotation vector determined by at least one processor of the set of earbuds based on motion data obtained from one or more motion sensors of the set of earbuds. Example configurations in accordance with the second mode are shown in and described above in connection with FIGS. 2A, 2D, and 2E. As yet another example, in a third mode, the rotation information may comprise YPR angles associated with a current head orientation of a wearer of the set of earbuds. An example configuration in accordance with the third mode is shown in and described above in connection with FIG. 2C.

At 1706, process 1700 can provide the rotation information to the paired mobile device. The rotation information may be provided via the wireless communication channel established during the pairing of the set of earbuds with the mobile device.

The mobile device may be configured to use the rotation information, optionally in conjunction with motion data and/or rotation information generated by the mobile device using one or more sensors of the mobile device, to determine a sound field rotation. The mobile device may then render audio content based on the determined sound field rotation. The rendered audio content may be played back by the set of earbuds.

FIG. 18 is a block diagram that shows examples of components of an apparatus capable of implementing various aspects of this disclosure. As with other figures provided herein, the types and numbers of elements shown in FIG. 18 are merely provided by way of example. Other implementations may include more, fewer and/or different types and numbers of elements. According to some examples, the apparatus 1800 may be configured for performing at least some of the methods disclosed herein. In some implementations, the apparatus 1800 may be, or may include, a television, one or more components of an audio system, a mobile device (such as a cellular telephone), a laptop computer, a tablet device, a smart speaker, or another type of device.

According to some alternative implementations the apparatus 1800 may be, or may include, a server. In some such examples, the apparatus 1800 may be, or may include, an encoder. Accordingly, in some instances the apparatus 1800 may be a device that is configured for use within an audio environment, such as a home audio environment, whereas in other instances the apparatus 1800 may be a device that is configured for use in “the cloud,” e.g., a server.

In this example, the apparatus 1800 includes an interface system 1805 and a control system 1810. The interface system 1805 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 1805 may, in some implementations, be configured for exchanging control information and associated data with audio devices of the audio environment. The control information and associated data may, in some examples, pertain to one or more software applications that the apparatus 1800 is executing.

The interface system 1805 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 1805 may include one or more network interfaces and/or one or more external device interfaces (such as one or more universal serial bus (USB) interfaces). According to some implementations, the interface system 1805 may include one or more wireless interfaces. The interface system 1805 may include one or more devices for implementing a user interface, such as one or more microphones, one or more speakers, a display system, a touch sensor system and/or a gesture sensor system. In some examples, the interface system 1805 may include one or more interfaces between the control system 1810 and a memory system, such as the optional memory system 1815 shown in FIG. 18. However, the control system 1810 may include a memory system in some instances. The interface system 1805 may, in some implementations, be configured for receiving input from one or more microphones in an environment.

The control system 1810 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 1810 may reside in more than one device. For example, in some implementations a portion of the control system 1810 may reside in a device within one of the environments depicted herein and another portion of the control system 1810 may reside in a device that is outside the environment, such as a server, a mobile device (e.g., a smartphone or a tablet computer), etc. In other examples, a portion of the control system 1810 may reside in a device within one environment and another portion of the control system 1810 may reside in one or more other devices of the environment. For example, a portion of the control system 1810 may reside in a device that is implementing a cloud-based service, such as a server, and another portion of the control system 1810 may reside in another device that is implementing the cloud-based service, such as another server, a memory device, etc. The interface system 1805 also may, in some examples, reside in more than one device. In some implementations, a portion of a control system may reside in or on an earbud.

In some implementations, the control system 1810 may be configured for performing, at least in part, the methods disclosed herein. According to some examples, the control system 1810 may be configured for implementing methods of determining rotation information, determining yaw, pitch, and roll angle, performing auto-zeroing procedures, performing calibration procedures, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 1815 shown in FIG. 18 and/or in the control system 1810. Accordingly, various innovative aspects of the subject matter described in this disclosure can be implemented in one or more non-transitory media having software stored thereon. The software may, for example, extract objects from a multi-channel audio signal, generate a spatial enhancement mask, apply a spatial enhancement mask, generate an output binaural audio signal, or the like. The software may, for example, be executable by one or more components of a control system such as the control system 1810 of FIG. 18.

In some examples, the apparatus 1800 may include the optional microphone system 1820 shown in FIG. 18. The optional microphone system 1820 may include one or more microphones. In some implementations, one or more of the microphones may be part of, or associated with, another device, such as a speaker of the speaker system, a smart audio device, etc. In some examples, the apparatus 1800 may not include a microphone system 1820. However, in some such implementations the apparatus 1800 may nonetheless be configured to receive microphone data for one or more microphones in an audio environment via the interface system 1810. In some such implementations, a cloud-based implementation of the apparatus 1800 may be configured to receive microphone data, or a noise metric corresponding at least in part to the microphone data, from one or more microphones in an audio environment via the interface system 1810.

According to some implementations, the apparatus 1800 may include the optional loudspeaker system 1825 shown in FIG. 18. The optional loudspeaker system 1825 may include one or more loudspeakers, which also may be referred to herein as “speakers” or, more generally, as “audio reproduction transducers.” In some examples (e.g., cloud-based implementations), the apparatus 1800 may not include a loudspeaker system 1825. In some implementations, the apparatus 1800 may include headphones. Headphones may be connected or coupled to the apparatus 1800 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method for determining headtracking information, the method comprising:
receiving, at a mobile device, motion information from a set of earbuds paired with the mobile device; and
determining rotation information associated with rotation to be applied to a sound field in accordance with a headtracking mode of operation, wherein:
in a first mode of the headtracking mode of operation, the motion information received from the set of earbuds corresponds to the determined rotation information,
in a second mode of the headtracking mode of operation, the motion information received from the set of earbuds comprises initial rotation information, and wherein the initial rotation information is combined with motion information obtained via one or more sensors of the mobile device to determine the rotation information, and
in a third mode of the headtracking mode of operation, the motion information received from the set of earbuds comprises motion sensor data, and wherein the motion sensor data is combined with motion information obtained via the one or more sensors of the mobile device to determine the rotation information.

2. The method of claim 0, further comprising detecting a motion activity of a wearer of the set of earbuds, wherein the determined rotation information is based at least in part on the detected motion activity.

3. The method of claim 0, wherein detecting the motion activity comprises determining whether the wearer is walking based at least in part on a comparison of a power of a frequency domain representation of the motion information to a threshold.

4. The method of claim 0, wherein the detecting the motion activity is performed by the set of earbuds.

5. The method of claim 0, wherein the detecting the motion activity is performed by the mobile device.

6. The method of claim 0, wherein the set of earbuds are configured to perform an auto-zeroing procedure to determine an updated reference axis corresponding to a user-facing direction, and wherein the determined rotation information is based at least in part on the reference axis.

7. The method of claim 0, wherein determining the reference axis comprises:
comparing a variance of a head orientation angle to a threshold;
determining that the variance of the head orientation angle is below the threshold for a predetermined duration of time; and
responsive to determining that the variance of the head orientation angle is below the threshold for the predetermined duration of time, determining the updated reference axis.

8. The method of claim 0, wherein the threshold is set based at least in part on the variance.

9. The method of claim 0, wherein the set of earbuds are configured to perform a calibration procedure configured to compensate for a tilt of at least one earbud of the set of earbuds within an ear of a wearer of the set of earbuds.

10. The method of claim 0, wherein the calibration procedure comprises determining a compensating rotation based on a quaternion representing an orientation of a head of the wearer.

11. The method of claim 0, wherein the mobile device is further configured to receive motion data from at least one other wearable device comprising at least one of: a smart watch, or a fitness tracker.

12. The method of claim 0, wherein in the third mode of the headtracking mode of operation, the mobile device is configured to combine the motion data from the at least one other wearable device with the motion information obtained via the one or more sensors of the mobile device to determine the rotation information.

13. The method of claim 0, wherein the mobile device:
determines that rotation information associated with rotation of the mobile device is to be used to determine the rotation to be applied to a sound field; and
determines the rotation information used to determine the rotation to be applied to the sound field based on a yaw angle of the mobile device.

14. The method of claim 0, wherein determining that the rotation information associated with the rotation of the mobile device is to be used to determine the rotation to be applied to the sound field comprises determining the rotation information associated with the rotation of the mobile device has a reliability that exceeds a reliability threshold, and that the mobile device has a stillness metric that is within a stillness threshold.

15. A system comprising:
one or more processors; and
a non-transitory computer-readable medium storing instructions that, upon execution by the one or more processors, cause the one or more processors to:
receive, at a mobile device, motion information from a set of earbuds paired with the mobile device; and
determine rotation information associated with rotation to be applied to a sound field in accordance with a headtracking mode of operation, wherein:
in a first mode of the headtracking mode of operation, the motion information received from the set of earbuds corresponds to the determined rotation information,
in a second mode of the headtracking mode of operation, the motion information received from the set of earbuds comprises initial rotation information, and wherein the initial rotation information is combined with motion information obtained via one or more sensors of the mobile device to determine the rotation information, and
in a third mode of the headtracking mode of operation, the motion information received from the set of earbuds comprises motion sensor data, and wherein the motion sensor data is combined with motion information obtained via the one or more sensors of the mobile device to determine the rotation information.

16. A non-transitory computer-readable medium storing instructions that, upon execution by one or more processors, cause the one or more processors to:
receive, at a mobile device, motion information from a set of earbuds paired with the mobile device; and
determine rotation information associated with rotation to be applied to a sound field in accordance with a headtracking mode of operation, wherein:
in a first mode of the headtracking mode of operation, the motion information received from the set of earbuds corresponds to the determined rotation information,
in a second mode of the headtracking mode of operation, the motion information received from the set of earbuds comprises initial rotation information, and wherein the initial rotation information is combined with motion information obtained via one or more sensors of the mobile device to determine the rotation information, and
in a third mode of the headtracking mode of operation, the motion information received from the set of earbuds comprises motion sensor data, and wherein the motion sensor data is combined with motion information obtained via the one or more sensors of the mobile device to determine the rotation information.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)
